(19) United States
(12) Patent Application Publication
(10) Pub. No.: US 2009/0251433 A1
(43) Pub. Date: Oct. 8, 2009

(54) TOUCH SENSING APPARATUS AND ELECTRONIC DEVICE CONNECTED TO TOUCH SENSING APPARATUS THEREOF

(76) Inventors: Young Un Park, Seongnam-si (KR); Deuk Hoi Kim, Seoul (KR)

Correspondence Address: BIRCH STEWART KOLASCH & BIRCH, PO BOX 747, FALLS CHURCH, VA, 22040-0747, US

(21) Appl. No.: 12/415,302

(22) Filed: Mar. 31, 2009

(30) Foreign Application Priority Data
Apr. 3, 2008 (KR) 10-2008-0031338

(51) Int. Cl. G06F 3/041

(52) U.S. Cl. 345/173

(57) ABSTRACT

A touch sensing device connected to a host processor of an electronic apparatus includes: a touch panel changing an electrical signal by a touch; and a touch sensing unit sensing the change in electrical signal and transmitting the electrical signal to the host processor. The touch sensing unit inputs an ENABLE signal for dropping a voltage or a DISABLE signal for intercepting the voltage to a voltage dropping unit on the basis of an operating status of the host processor or the change in electrical signal. The voltage dropping unit is disposed in the electronic apparatus and drops or intercepts the voltage to be applied to the host processor. According to this configuration, it is possible to reduce the power consumption of the host processor.

### BACKGROUND

1. Field of the Invention

The present invention relates to a touch sensing device and an electronic apparatus connected to the touch sensing device, and more particularly, to a touch sensing device capable of controlling a power mode of a host processor of an electronic apparatus and an electronic apparatus connected to the touch sensing device.

2. Related Art

Electronic apparatuses have been developed to multi-functional electronic apparatuses capable of executing a variety of functions. The variety of functions could be embodied by a host processor merging individual operation modules (or embedded modules) capable of executing the functions, respectively, and comprehensively controlling the operation modules.

Since the embodiment of the multi-functions necessarily causes an increase in power consumption, it is very important to reduce the power consumption of the electronic apparatuses. Particularly, since portable electronic apparatuses (such as a notebook computer, a mobile terminal, or a PDA) are supplied with power from a charged battery, consumers' important criterion for selecting an electronic apparatus is the time when the electronic apparatus could work with a defined battery.

Accordingly, studies for improving power consumption characteristics of constituent elements of the operation modules have been made to reduce the power consumption of the electronic apparatuses, but the countermeasure for reducing the power consumption of the host processor comprehensively controlling the operations modules is not suggested yet.

By only pushing a power button (for example, an OFF button) of an electronic apparatus, the power consumption of the electronic apparatus does not become zero. Even when the operation modules of the electronic apparatus stop their operations, the host processor comprehensively controlling the operation modules still consumes power in an idle mode (idle state).

For example, in a PDA which is turned off, the host processor waits in an idle mode. This is because the PDA should start its operation just when a signal is input through an input unit included in or connected to the PDA. Therefore, the host processor continuously consumes the power in the idle mode, so long as a battery is not separated from the PDA and power is not supplied thereto.

In a portable PDA, since the carrying time of the PDA is much greater than the operating time of the PDA, the sum of power consumption of the host processor in the idle mode is not small.

### SUMMARY

An advantage of some aspects of the invention is that it provides a touch sensing device controlling a host processor to switch an idle mode to a deactivated mode so as to allow the host processor in the idle mode not to consume power.

Another advantage of some aspects of the invention is that it provides a touch sensing device controlling a host processor, which is switched to a deactivated mode under the control of the touch sensing device, to switch the deactivated mode to an activated mode in accordance with a touch signal sensed by the touch sensing device or an infrared signal.

Other advantages of the invention will be apparently understood from exemplary embodiments to be described later.

According to an aspect of the invention, there is provided a touch sensing device connected to a host processor of an electronic apparatus.

The touch sensing device includes: a touch panel changing an electrical signal by a touch; and a touch sensing unit sensing the change in electrical signal and transmitting the electrical signal to the host processor. Here, the touch sensing unit inputs an ENABLE signal for dropping a voltage or a DISABLE signal for intercepting the voltage to a voltage dropping unit on the basis of an operating status of the host processor or the change in electrical signal, and the voltage dropping unit is disposed in the electronic apparatus and drops or intercepts the voltage to be applied to the host processor.

According to another aspect of the invention, there is provided an electronic apparatus.

The electronic apparatus includes: a host processor connected to a touch sensing device sensing a change in electrical signal due to a touch; a voltage dropping unit dropping or intercepting a voltage to be applied to the host processor; and an operation executing unit executing a user's operation instruction input by sensing a touch under the control of the host processor. Here, the voltage dropping unit receives an ENABLE signal for dropping the voltage or a DISABLE signal for intercepting the voltage from the touch sensing device and drops or intercepts the voltage.

According to another aspect of the invention, there is provided a method of controlling a touch sensing device, which is connected to a host processor of an electronic apparatus, to switch an operation mode of the host processor.

The method includes the steps of: (a) determining whether the host processor is in an idle mode; and (b) inputting a DISABLE signal to a voltage dropping unit applying a voltage to the host processor when it is determined that the host processor is in the idle mode. Here, the voltage dropping unit receiving the DISABLE signal stops the application of a voltage.

According to the above-mentioned configurations of the invention, since the host processor need not maintain the idle mode, it is possible to reduce the power consumption of the host processor.

According to the above-mentioned touch sensing device, it is possible to control the host processor to switch the deactivated mode to the idle mode in accordance with a touch signal or an IR signal.

### BRIEF DESCRIPTION OF THE DRAWINGS

FIG. 1 is a diagram illustrating a configuration of a touch sensing device according to an embodiment of the invention and a configuration of an electronic apparatus connected to touch sensing device.

FIG. 2 is a diagram illustrating a configuration of a touch sensing device according to another embodiment of the invention and a configuration of an electronic apparatus connected to the touch sensing device.

FIG. 3 is a flow diagram illustrating a procedure of controlling a touch sensing device to control a mode of a host processor.

### DESCRIPTION OF EXEMPLARY EMBODIMENTS

The invention can be variously modified in various embodiments and specific embodiments will be described and shown in the drawings. It should be understood that the invention is not limited to the embodiments but includes all modifications, equivalents, and replacements belonging to the technical spirit and scope of the invention.

If it is mentioned that an element is “connected to” or “coupled to” another element, it should be understood that the element may be connected or coupled directly to another element or that still another element may be interposed therebetween. On the contrary, if it is mentioned that an element is “connected directly to” or “coupled directly to” another element, it should be understood that still another element is not interposed therebetween.

The terms used in the following description are used to merely describe specific embodiments, but are not intended to limit the invention. An expression of the singular number includes an expression of the plural number, so long as it is clearly read differently. The terms such as “include”, “have”, and the like are intended to indicate that features, numbers, steps, operations, elements, components, or combinations thereof used in the following description exist and that the possibility of existence or addition of one or more different features, numbers, steps, operations, elements, components, or combinations thereof is not excluded.

So long as they are not defined differently, all the terms used therein, which include technical or scientific terms, have the same meanings as generally understood by those skilled in the art. It should be analyzed that the terms defined in dictionaries used in general have the same meaning as in the contexts of the related art, but the terms should not be analyzed ideal or excessively formal.

Hereinafter, exemplary embodiments of the invention will be described in detail with reference to the accompanying drawings.

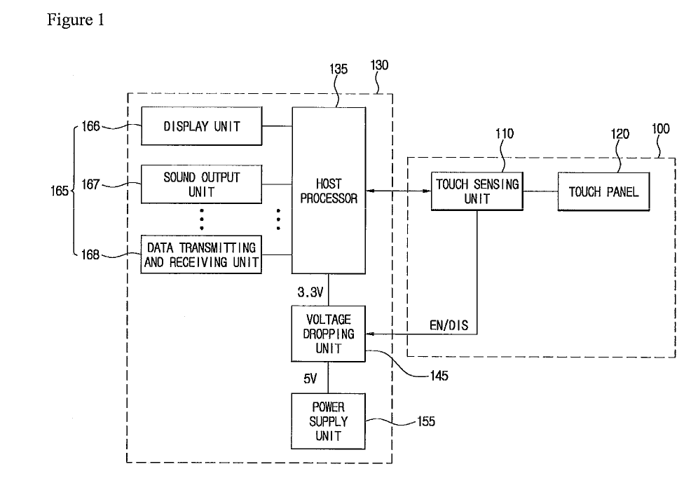

FIG. 1 is a diagram illustrating a configuration of a touch sensing device according to an embodiment of the invention and a configuration of an electronic apparatus connected to touch sensing device.

Referring to FIG. 1, a touch sensing device 100 includes a touch sensing unit 110 and a touch panel 120. An electronic apparatus 130 includes a host processor 135, a voltage drop unit 145, and a power supply unit 155.

The electronic apparatus 130 can include various operation modules 165 performing specific operations of the electronic apparatus 130, but the invention is not limited to the operations to be performed the operation modules 165.

In the following description, for the purpose of convenient explanation, it is assumed that the electronic apparatus 130 includes a display unit 166, a sound output unit 167, and a data transmitting and receiving unit 168 as the operation modules 165. The display unit 166, the sound output unit 167, and the data transmitting and receiving unit 168 may include a control circuit (embedded system). In this case, the units can transmit and receive data to and from the host processor 135 in accordance with a predetermined communication standard (for example, MIPI Alliance in case of a mobile apparatus).

The host processor 135 can directly control the operations of the operation modules 165 or can control the operations of the operation modules 165 by transmitting an operation instruction corresponding to a user's input to the operation modules 165.

The host processor 135 is a micro computer (μCOM) including integrated circuits (IC), which can perform input and output of data and calculation and processing of data and can be designed to operate by predetermined programs. For example, by calculating coordinates and color values (RGB brightness values) and transmitting the calculated values to the display unit 166 to output a 3D image, the corresponding 3D image can be output from the display unit. When the display unit 166 is an embedded system and includes a graphic IC, the host processor 135 may perform a function of transmitting an operation instruction such as brightness values designated by the user to the display unit 166.

The host processor 135 can control the operations of the sound output unit 167 and the data transmitting and receiving unit 168, similarly to the display unit 166. The host processor 135 may synchronize the sound output unit 167 and the data transmitting and receiving unit 168 with each other.

The control function of the host processor 135 is based on the premise that the host processor is in an activated mode when the user utilizes the electronic apparatus to watch a moving image or to listen to the music. The activated mode means a mode in which the host processor 135 performs calculation, storage, or processing of data. Therefore, the host process 135 consumes a great amount of power in the activated mode.

When the user does not utilize but simply carries the electronic apparatus 130, the user turns off the electronic apparatus. The turning-off may be performed by pushing a power button (not shown) particularly disposed in the electronic apparatus or may be performed by the use of an IR remote controller (not shown) or the touch sensing device 100.

When it is turned off, the host processor 135 stops the operations of the operation modules 165 in operation. A process of storing the operation states of the operation modules 165, image data, or the like in a memory can be performed depending on the type of the electronic apparatus 130. A particular storage process may not be performed depending on the type and the set state of the electronic apparatus 130.

When the storage process is finished or just after it is turned off, the host processor 135 enters an idle mode. The idle mode is a state where the host processor 135 is in an operable state but does not operate and means a state where the host processor 135 waits to instantaneously perform an external instruction.

The idle mode is different from a deactivated mode where the power is completely intercepted. The deactivated mode means a state where the host processor 135 is completely electrically (or virtually) disconnected from a power supply unit 155 such as a battery and does not react to any input signal. The power consumption in the idle mode is smaller than the power consumption in the activated mode but may be greater than the power consumption in the activated mode when the waiting time in the idle mode is elongated.

The touch sensing unit 110 of the touch sensing device 100 according to this embodiment is connected to the host processor 135 and serves to control the host processor 135 to switch its operation mode between the idle mode and the deactivated mode.

The touch sensing device 100 according to this embodiment senses a user's touch input from the touch panel 120 and also monitors the operation mode of the host processor 135. The operation modes of the host processor 135 can be classified into an activated mode, an idle mode, and a deactivated mode, and the touch sensing device 100 can determine the operation mode of the host processor 135 by receiving mode information for identifying the modes from the host processor 135.

That is, to reduce the power consumption in the idle mode, the touch sensing device 100 determines whether the host processor 135 is in the idle mode and switches the operation mode of the host processor 135 to the deactivated mode, as described above. Accordingly, it is possible to reduce the power consumption in the idle mode for a long time.

However, when the host processor 135 is in the deactivated mode, it is not in the idle state, and thus does not operate by any input from the user. Accordingly, the touch sensing device 130 according to this embodiment monitors the user's input and switches the host processor 135 from the deactivated mode to the activated mode in response to the user's input.

Even when the host processor 135 does not always wait for the user's input in the idle mode, the touch sensing device 130 according to this embodiment senses the user's input and switches the operation mode of the host processor 135 to the activated mode. Accordingly, the host processor 135 can instantaneously perform the user's input instruction.

Since the touch sensing device 130 according to this embodiment is connected to the host processor 135 and the voltage dropping unit 145, the touch sensing device 130 can switch the operation mode of the host processor 135.

The voltage dropping unit 145 may be an LDO (Low-Drop Out) regulator being included in the electronic apparatus and dropping a voltage supplied from the power supply unit 155. Since the detailed configuration of the LDO regulator including one or more transistors is various and is obvious to those skilled in the art, the detailed description thereof is omitted.

The voltage dropping unit 145 drops a source voltage of, for example, 5 V to 3.3 V and applies 3.3 V to the host processor 135, so as to apply an operating voltage allowing the host processor 135 to operate as previously designed for the electronic apparatus 130 according to this embodiment. The voltages of 5 V and 3.3 V are obviously only examples for explaining the invention and thus may be replaced with other voltages.

The voltage dropping unit 145 is connected to the touch sensing unit 110 of the touch sensing device according to this embodiment. The touch sensing unit 110 inputs an ENABLE signal or a DISABLE signal to the voltage dropping unit 145, so that the voltage dropping unit 145 drops the voltage of 5 V to 3.3 V (activated mode or idle mode) or 1.3 V (idle mode) or intercept (disconnect or virtually disconnect) the voltage of 5 V to 0 V (deactivated mode).

That is, the voltage dropping unit 145 connected to the touch sensing device 100 according to this embodiment switches the operation mode of the host processor between the activated mode or the idle mode and the deactivated mode.

When the touch sensing device 100 inputs the ENABLE signal to the voltage dropping unit 145, the host processor 135 is supplied with the voltage of 3.3 V from the voltage dropping unit 145 and thus the host processor 135 is in the activated mode or the idle mode. The voltage of 3.3 V may be applied in both the activated mode and the idle mode depending on the types of the host processor 135 and the voltage dropping unit 145. The voltage of the activated mode and the idle mode is different from the deactivated mode in which the voltage of 0 V is applied.

When the touch sensing device 100 inputs the DISABLE signal to the voltage dropping unit 145, the host processor 135 is supplied with the voltage of 0 V from the voltage dropping unit 145 and thus the host processor 135 is in the deactivated mode.

When the touch sensing device 100 inputs the DISABLE signal to the voltage dropping unit 145, the host processor 135 is in the idle mode. That is, the touch sensing device 100 determines the operation mode of the host processor 135 by inquiring of the host processor 135 the operation mode of the host processor 135 with a predetermined period or receiving mode information from the host processor 135.

When the host processor 135 is in the idle mode, power is consumed as described above and the host processor 135 is supplied with the voltage of 3.3 V or 1.3 V from the voltage dropping unit 145. Therefore, a constant amount of power is consumed while the user is merely carrying the electronic apparatus 130.

However, since the touch sensing device 100 according to this embodiment capable of sensing the user's input is connected to the host processor 135 and the voltage dropping unit 145, the host processor 135 need not be maintained in the idle mode. Therefore, the touch sensing device 100 according to this embodiment does not apply any voltage to the host processor 135 from the voltage dropping unit 145 by inputting the DISABLE signal to the voltage dropping unit 145. The host processor 135 not supplied with any voltage is switched to the deactivated mode.

Since the power consumed by the host processor 135 in the deactivated mode is zero, it is possible to reduce the power consumed by the host processor 135 in the idle mode.

On the contrary, when the user brings a dielectric body (for example, a finger or a stylus) into contact with the touch panel 120 and inputs a turning-on instruction and a reproduction instruction, the touch sensing device 100 senses the input, which will be described later.

The touch sensing device 100 having sensed the user's touch input inputs the ENABLE signal to the voltage dropping unit 145. The voltage dropping unit 145 receives the ENABLE signal and applies the voltage dropped from 5 V to 3.3 V to the host processor 135. Accordingly, the host processor 135 is switched from the deactivated mode to the idle mode.

At the same time or at a different time, the touch sensing unit 110 transmits the sensed touch signal to the host processor 135. Accordingly, the host processor 135 is switched to the activated mode while allowing the display unit 166, the sound output unit 167, and the like to operate depending on the type of the touch signal (for example, a turning-on instruction).

The touch sensing unit 110 included in the touch sensing device 100 according to this embodiment is a controller including an IC circuit for sensing a change in electrical signal due to the user's touch from the touch panel 120. Accordingly, the touch sensing unit 110 is an independent controller different from the host processor 135 of the electronic apparatus 130 and serves to sense the user's touch via the touch panel 120 and to transmit the touch signal to the host processor 135. The transmission of the touch signal obviously includes analog-digital conversion and synchronization.

The touch sensing device 100 senses the user's touch input via the touch panel 120. A scheme for sensing the user's touch input can include an electrostatic scheme, a resistance scheme, a pressure scheme, an optical scheme, and an ultrasonic scheme. The electrostatic scheme includes a scheme of sensing a change in accumulated voltage due to a change in electrostatic capacitance and a scheme of generating a clock signal in accordance with a change in oscillation frequency of an internal oscillation unit, counting a value with a counter, and comparing the counted value with the clock signal. The touch sensing device according to this embodiment is not limited to one of the above-mentioned sensing schemes, but any may be employed by the touch sensing device 100 according to this embodiment so long as it can sense the user's touch.

The touch panel 120 may be a panel group including one or more panels. For example, when the electronic apparatus 130 is a PMP (Portable Media Player), five touch panels 120 corresponding to power, reproduction, stop, rewind, and forward wind may be employed.

When the user brings a dielectric body (such as a finger or a stylus) into contact with the touch panel 120, the change in electrostatic capacitance using the touch panel as one electrode causes a change in electrical signal. Accordingly, the touch sensing device 100 can sense the change in electrical signal by the touch panels 120. Therefore, the touch sensing device 100 serves as an input unit capable of allowing the user to give an input instruction for operating the electronic apparatus.

The touch sensing device 100 is not a unique input unit connected to the host processor 135, but input units such as a button type keypad, a sound input unit, and a keyboard may be obviously connected to the host processor 135 in addition to the touch sensing device 100.

The touch sensing device 100 may be disposed inside the electronic apparatus 130 so as to be connected to the host processor 135 and may be disposed as an independent device outside the electronic apparatus so as to be electrically connected to the electronic apparatus 130.

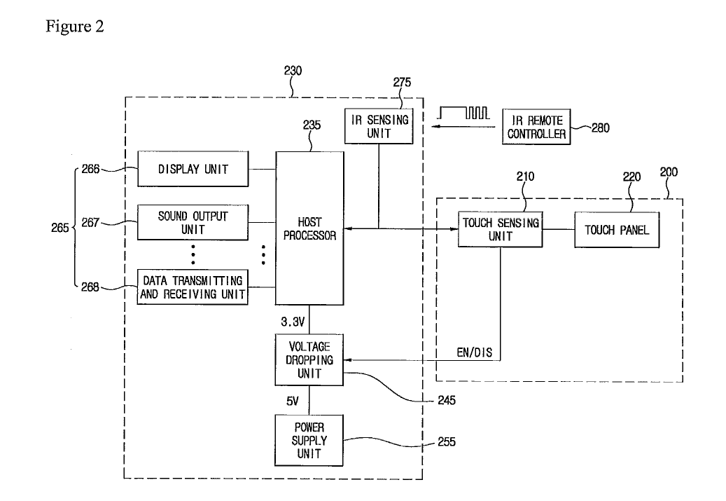

FIG. 2 is a diagram illustrating a configuration of a touch sensing device according to another embodiment of the invention and a configuration of an electronic apparatus connected to the touch sensing device.

Referring to FIG. 2, the electronic apparatus 230 further includes an IR (InfraRed) sensing unit 275. Accordingly, a user can control the electronic apparatus 230 by the use of an IR remote controller 280.

The IT sensing unit 275 is a sensor including an infrared light receiving portion (not shown) and serves to convert a received infrared ray into an electrical signal and to transmit the electrical signal to the host processor 235 and the touch sensing unit 210. The host processor 235 controls the operation of the operation modules 265 on the basis of information included in the IR signal transmitted from the IR sensing unit 275.

The IR remote controller 280 can use an IR LED (not shown) as a light source of the infrared ray that can be received by the IR sensing unit 275. The IR LED emits an IR pulse signal in a frequency range of 30 kHz to 40 kHz. The pulse frequency band of 30 kHz to 40 kHz does not allow the IR sensing unit to interfere with light emitted from another light source and may be replaced with other frequency band.

The IR pulse signal is transmitted in the form of binary code and different IR pulse signals can be emitted depending on the coding method thereof. For example, a pulse width coded signal in which a short pulse is coded to 0 and a long pulse is coded to 1 or a space coded signal in which 0 and 1 are distinguished by space lengths between the pulses can be used. A shift coded signal in which the rising edge is coded to 0 and the falling edge is coded to 1 depending on a pulse transition direction can be also used.

Therefore, a pre-coded IR signal is emitted by the user's operation of the IR remote controller 280, and the IR sensing unit 275 receives and converts the IR signal into an electric signal and transmits the electrical signal to the host processor 235 or the touch sensing unit 210. However, only when a preset header is added to the IR signal, the IR sensing unit 275 can transmit the IR signal to the host processor 235 or the touch sensing unit 210.

The IR signal includes both a header and a code, where the header serves as an identifier for allowing the IR sensing unit 275 to distinguish the IR signal from a noise. Accordingly, when a pulse having a duration width of several msec is not added as the header, the IR sensing unit 275 does not recognize the sensed IR signal as a normal IR signal and thus does not transmit the sensed IR signal to the host processor 235 or the touch sensing unit 210.

In order for the host processor 235 to receive the IR signal and control the operation modules 265, the host processor 235 should be in the activated mode or the idle mode. That is, when the host processor 235 is in the activated mode, the host processor 235 can control the electronic apparatus 230 on the basis of the signal transmitted from the IR sensing unit 275 without any problem.

However, as described with reference to FIG. 1, since the touch sensing device 200 according to this embodiment switches the host processor 235 in the idle mode to the deactivated mode, the host processor 235 in the deactivated mode cannot receive the IR signal transmitted from the IR sensing unit 275.

Accordingly, a touch sensing device 200 according to another embodiment of the invention switches the host processor 235 to the activated mode or the idle mode, when receiving the IR signal from the IR sensing unit 275. That is, the touch sensing device 200 is connected to the IR sensing unit 275 and receives the IR signal transmitted from the IR sensing unit 275. The IR sensing unit 275 is connected to a multiplexer (not shown) and concurrently transmits the IR signal to the host processor 235 and the touch sensing unit 210.

Therefore, the touch sensing device 200 according to another embodiment of the invention can sense a touch of the touch panel 220 and can receive the IR signal sensed by the IR sensing unit 275 and switch the host processor 235 from the deactivated mode to the idle mode. The host processor 235 switched to the activated mode or the idle mode is switched to the activated mode while allowing the operation modules 265 to operate in accordance with the IR signal.

For example, when a play instruction is included in the IR signal sensed by the IR sensing unit 275, the host processor 235 controls a display unit 266 and a memory (not shown) to play the corresponding moving image. That is, the host processor 235 reads the corresponding moving image from the memory and transmits the read moving image to the display unit 266 so as to allow the display unit 266 to play the moving image. The host processor 235 allows a sound output unit 267 to output sound data of the moving image in synchronization with the moving image of the display unit 266.

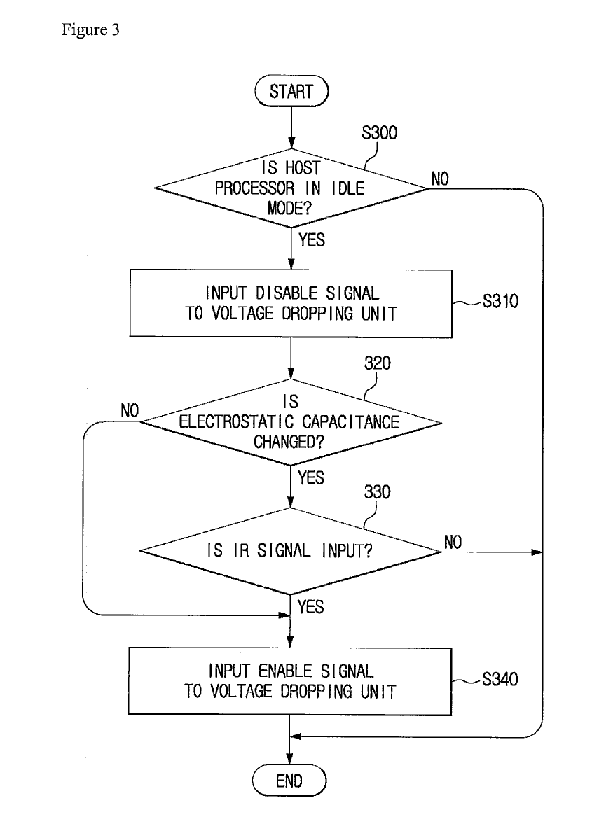

FIG. 3 is a flow diagram illustrating a procedure of allowing a touch sensing device to control an operation mode of a host processor.

Referring to FIG. 3, the touch sensing device determines whether the host processor is in the idle mode (S300). The touch sensing device can determined the operation mode of the host processor by receiving mode information of the host processor from the host processor with a predetermined time period or inquiring of the host processor in accordance with a predetermined communication protocol.

When the host processor is not in the idle state, it means that the host processor is in the activated mode or the deactivated mode. Accordingly, the ENABLE or DISABLE signal is not input to the voltage dropping unit. That is, since the host processor controls the operation modules or the power supply is intercepted due to the previous input, the host processor maintains its operation mode.

However, when it is determined in step S300 that the host processor is in the idle mode, the touch sensing device according to this embodiment inputs the DISABLE signal to the voltage dropping unit so as to switch the host processor from the idle mode to the deactivated mode (S310).

As the result of step S310, the voltage dropping unit intercepts the voltage applied to the host processor to switch the host processor from the idle mode to the deactivated mode. Accordingly, the host processor does not consume power any more. However, the touch sensing device is continuously supplied with power and monitors the user's touch input or the IR input. In the known electronic apparatus, since the host processor is in the idle mode, the touch sensing device and the host processor should consume power doubly. Compared with this known electronic apparatus, it is possible to markedly reduce the power consumption.

The touch sensing device being monitoring the input senses a change in electrostatic capacitance occurring in the touch panel (S320).

The touch sensing device sensing the change in electrostatic capacitance inputs an ENABLE signal to the voltage dropping unit (S340).

Accordingly, as the result of step S340, the voltage dropping unit drops the voltage of 5 V to 3.3 V and applies the dropped voltage to the host processor, and the host processor is switched to the activated mode or the idle mode.

The touch sensing unit can distinguish the instructions depending on the number of touch panels and types of the touch panels. Accordingly, the touch sensing unit can input the ENABLE signal to the voltage dropping unit, only when a signal resulting from the change in electrostatic capacitance of the touch panel is sensed among the plural touch panels. However, in case of signals of play, stop, fast wind, and the like, the ENABLE signal may be input to the voltage dropping unit in step S340, depending on the setting of the electronic apparatus and the touch sensing device.

When the IR sensing unit senses an IR signal (S330), the IR sensing unit transmits the IR signal to the touch sensing device and thus the touch sensing device can determined whether a user inputs an instruction by the use of the IR remote controller.

The host processor in the deactivated mode cannot receive the signal transmitted from the IR sensing unit and cannot control the operations of the operation modules. Therefore, the touch sensing device according to the embodiments of the invention inputs the ENABLE signal to the voltage dropping unit in step S340.

The voltage dropping unit drops the voltage of 5 V to 3.3 V and applies the dropped voltage to the host processor. Accordingly, the host processor can be switched to the activated mode or the idle mode to control the operations of the operation modules corresponding to the IR signal.

However, as described with reference to FIG. 2, the IR signal should include the header for distinguishing the effective IR signal from a noise. The IR sensing unit may determine the presence of the header and transmit the filtered IR signal to the touch sensing device, or the touch sensing device may determine the presence of the header.

Therefore, the touch sensing device can control the switching between the idle mode and the deactivated mode to greatly reduce the power consumption of the host process in the idle mode. However, since the waiting for the user's input instruction at the time of switching the host processor from the idle mode to the deactivated mode can be carried out by the touch sensing device, the user's input instruction can be executed at once at any time.

The above-mentioned method according to the invention can be embodied as a program and can be stored in a computer-readable recording medium (such as CD-ROM, RAM, ROM, floppy disk, hard disk, and magneto-optical disk).

What is claimed is:

1. A touch sensing device connected to a host processor of an electronic apparatus, the touch sensing device comprising:
a touch panel changing an electrical signal by a touch; and
a touch sensing unit sensing the change in electrical signal and transmitting the electrical signal to the host processor,
wherein the touch sensing unit inputs an ENABLE signal for dropping a voltage or a DISABLE signal for intercepting the voltage to a voltage dropping unit on the basis of an operating status of the host processor or the change in electrical signal, and
wherein the voltage dropping unit is disposed in the electronic apparatus and drops or intercepts the voltage to be applied to the host processor.

2. The touch sensing device according to claim 1, wherein when the host processor is in an idle mode, the touch sensing unit inputs the DISABLE signal to the voltage dropping unit to intercept the voltage and thus to switch an operation mode of the host processor to a deactivated mode.

3. The touch sensing device according to claim 1, wherein when the host processor is in a deactivated mode and the touch sensing unit senses the change in electrical signal, the touch sensing unit inputs the ENABLE signal to the voltage dropping unit to drop the voltage and thus to switch an operation mode of the host processor to an idle mode.

4. An electronic apparatus comprising:
a host processor connected to a touch sensing device sensing a change in electrical signal due to a touch;
a voltage dropping unit dropping or intercepting a voltage to be applied to the host processor; and
an operation executing unit executing a user's operation instruction input by sensing a touch under the control of the host processor,
wherein the voltage dropping unit receives an ENABLE signal for dropping the voltage or a DISABLE signal for intercepting the voltage from the touch sensing device and drops or intercepts the voltage.

5. The electronic apparatus according to claim 4, further comprising an IR sensing unit transmitting a sensed IR signal to the host processor and the touch sensing device,
wherein when the host processor is in a deactivated mode and the IR sensing unit transmits the IR signal to the touch sensing device, the touch sensing device inputs the ENABLE signal to the voltage dropping unit to drop the voltage and thus to switch an operation mode of the host processor to an idle mode.

6. The electronic apparatus according to claim 5, wherein the IR signal includes a header, and
wherein the IR sensing unit or the touch sensing device distinguish the IR signal from a noise on the basis of the header.

7. A method of controlling a touch sensing device, which is connected to a host processor of an electronic apparatus, to switch an operation mode of the host processor, the method comprising the steps of:
(a) determining whether the host processor is in an idle mode; and
(b) inputting a DISABLE signal to a voltage dropping unit applying a voltage to the host processor when it is determined that the host processor is in the idle mode,
wherein the voltage dropping unit receiving the DISABLE signal stops the application of a voltage.

8. The method according to claim 7, further comprising the step of (c) inputting an ENABLE signal to the voltage dropping unit when the touch sensing device senses an electrical signal generated due to a touch or the touch sensing device receives an IR signal,
wherein an IR sensing unit disposed in the electronic apparatus senses and transmits the IR signal to the touch sensing device and the voltage dropping unit receiving the ENABLE signal drops the voltage and applies the dropped voltage to the host processor.
